(19) United States
(12) Patent Application Publication
(10) Pub. No.: US 2026/0250197 A1
(43) Pub. Date: Aug. 27, 2026

(54) PROCESS FOR IMPROVING CRACK RESISTANCE OF RECYCLED AGGREGATE CONCRETE

(71) Applicant: WUHAN UNIVERSITY, Wuhan City (CN)

(72) Inventors: Yiyan LU, Wuhan City (CN); Yuhong YAN, Wuhan City (CN); Yue HUANG, Wuhan City (CN); Shan LI, Wuhan City (CN)

(21) Appl. No.: 19/531,845

(22) Filed: Feb. 6, 2026

(30) Foreign Application Priority Data
Feb. 25, 2025 (CN) 202510217474.X

(51) Int. Cl. C04B 20/12; C04B 18/06; C04B 18/08; C04B 18/167; C04B 20/10; C04B 103/60; C04B 111/20

(52) U.S. Cl. CPC C04B 20/12; C04B 18/067; C04B 18/08; C04B 18/167; C04B 20/1051; C04B 20/1077; C04B 2103/60; C04B 2111/2038

(57) ABSTRACT

A process for improving crack resistance of recycled aggregate concrete is provided. The process includes following steps: (1) soaking recycled fine aggregate in an organosilicon compound for modification, thereby obtaining modified fine aggregate; (2) soaking recycled coarse aggregate in a silica sol solution, then adding quicklime, thereby obtaining modified recycled coarse aggregate; and (3) mixing cement, carbide slag, fly ash and an additive with water until uniform, then sequentially adding the modified fine aggregate and the modified recycled coarse aggregate and mixing uniformly, finally performing later-stage curing to obtain the recycled aggregate concrete.

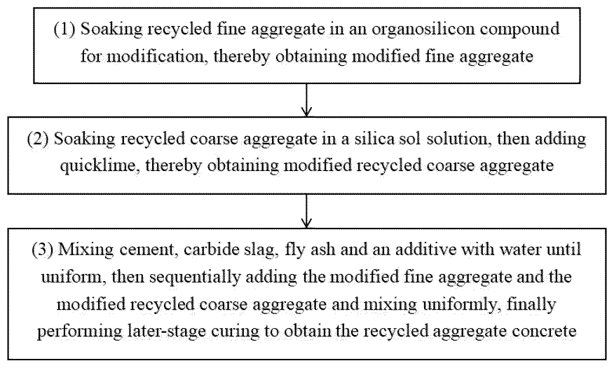

### CROSS-REFERENCE TO RELATED APPLICATIONS

This application claims priority to Chinese Patent Application No. 202510217474.X, filed on Feb. 25, 2025, the contents of which are hereby incorporated by reference.

### TECHNICAL FIELD

The present disclosure belongs to the technical field of recycled concrete, and particularly relates to a process for improving crack resistance of recycled aggregate concrete.

### BACKGROUND

Crack resistance of concrete refers to its ability to resist cracking, which is an important manifestation of the comprehensive performance of concrete material. This performance is closely related to multiple factors of concrete, such as tensile strength, ultimate tensile deformation capacity, tensile elastic modulus, autogenous volume deformation, creep, and thermal properties. However, in practical applications, crack resistance of concrete still faces many problems and challenges. Firstly, from the perspective of the concrete material itself, its tensile strength is much lower than its compressive strength, and its ultimate tensile deformation is also very small, making concrete prone to developing cracks or microcracks under external forces, temperature changes, moisture changes, and other influences. These cracks or microcracks not only affect the integrity and durability of buildings but may even threaten the safety and stability of structures. Cracks are mainly classified into three types: stress cracks, drying shrinkage cracks, and temperature cracks, and the occurrence of these cracks is related to the insufficient crack resistance of concrete.

In the prior art, although a series of measures have been adopted to improve crack resistance of concrete, such as using low-heat cement, various additives, and implementing surface insulation measures, certain problems still persist. For example, an unreasonable water-cement ratio is an important reason for poor crack resistance of concrete. An excessively high water-cement ratio increases voids inside the concrete, making it prone to cracking; while an excessively low water-cement ratio may affect the fluidity of concrete, leading to construction difficulties, and excessive cement usage also increases heat generation and drying shrinkage rate of concrete, thereby reducing crack resistance. Additionally, issues such as uneven ingredient mixing, insufficient reinforcement density, and insufficient prestress also affect crack resistance of concrete. Uneven ingredient mixing leads to inhomogeneous concrete structure, making it prone to cracking. Insufficient reinforcement density may not effectively support tensile forces in concrete, easily causing cracks. Insufficient prestress may not effectively reduce internal compressive stress in concrete, thereby lowering crack resistance of concrete.

Therefore, how to provide a method capable of improving crack resistance of recycled concrete is a technical problem urgently needing solution by those skilled in the art.

### SUMMARY

To address the above technical problem, the present disclosure proposes a process for improving crack resistance of recycled aggregate concrete.

To achieve the above objective, the present disclosure provides the following technical scheme.

A process for improving crack resistance of recycled aggregate concrete includes the following steps:
(1) soaking recycled fine aggregate in an organosilicon compound for modification, thereby obtaining modified fine aggregate;
(2) soaking recycled coarse aggregate in a silica sol solution, then adding quicklime, thereby obtaining modified recycled coarse aggregate; and
(3) mixing cement, carbide slag, fly ash and an additive with water until uniform, then sequentially adding the modified fine aggregate and the modified recycled coarse aggregate and mixing uniformly, finally performing later-stage curing to obtain recycled aggregate concrete.

Beneficial effects: In the present disclosure, by soaking recycled fine aggregate in an organosilicon compound, a thin film of organosilicon compound may be formed on the surface of the fine aggregate. This thin film may improve the interfacial bonding force between the fine aggregate and the cement paste, reducing the generation of microcracks at the interface. Meanwhile, in the present disclosure, by soaking recycled coarse aggregate in a silica sol solution and then adding quicklime for reaction, a dense layer of calcium silicate gel may be formed on the surface of the coarse aggregate. This gel layer may enhance the bonding force between the coarse aggregate and the cement paste, improving the overall strength of the concrete. Furthermore, the reaction between the silica sol and quicklime may also consume pores and cracks on the surface of the coarse aggregate, reducing the intrusion of moisture and harmful substances, thereby improving the durability and crack resistance of the coarse aggregate.

In addition, the present disclosure employs a two-stage mixing method during the raw material mixing process, first mixing cement, carbide slag, fly ash, and an additive with water to ensure thorough mixing of various materials, forming a homogeneous mixture, as this homogeneity is crucial for the later-stage strength and durability of concrete, and then sequentially adding the modified recycled fine aggregate and the modified recycled coarse aggregate for mixing, allowing the aggregates to be uniformly dispersed within the mixture, which helps reduce voids between aggregates, improving the compactness and strength of concrete. During this process, the surface modification treatment of the modified fine aggregate and the modified recycled coarse aggregate enhances the interfacial bonding force between them and the cement paste, and this enhancement helps reduce the generation of microcracks at the interface, improving the crack resistance of concrete. Moreover, the second mixing stage may further improve the workability of concrete, such as enhancing fluidity and reducing segregation and bleeding phenomena, which helps concrete achieve better compactness and uniformity during pouring and vibration. Through the two mixing stages, various materials in the concrete may be thoroughly mixed and uniformly dispersed, and hydration reactions may proceed sufficiently. Meanwhile, the application of modified aggregates enhances interfacial bonding force and improves the workability of concrete. The combined effects of these factors enable the finally obtained concrete to exhibit excellent strength, durability, and crack resistance.

Optionally, the mass ratio of the cement, carbide slag, fly ash, additive, modified fine aggregate and modified coarse aggregate is 1:(0.1-0.3):(0-0.3):(0.01-0.05):(0.2-0.5):(0.2-0.5).

The amount of water added should be such that the water-cement ratio of the concrete system is controlled within the range of 0.35-0.60 water/cement.

Beneficial effects: Under the above raw material addition amounts, the mechanical properties and crack resistance of the concrete may be effectively improved. In particular, the incorporation of fly ash may fill pores and cracks inside the concrete, reducing the shrinkage deformation of the concrete, thereby improving its crack resistance. Furthermore, the carbide slag in the present disclosure has high activity and contains substances such as calcium oxide and silicon oxide. These components may undergo chemical reactions with other components in cement, generating new hydration products, thereby enhancing the strength of the concrete. The incorporation of carbide slag may refine the pore structure of concrete, reduce the number of harmful pores, improve the compactness and impermeability of concrete, and the active components in it may stimulate the potential hydration activity in cement, further improving the durability of the concrete.

Optionally, the recycled fine aggregate is waste brick fine aggregate, with a particle size of 0.2-6 millimeters.

Optionally, the waste brick fine aggregate has an SiO₂ content of 55-61 weight percent and an Al₂O₃ content of 22-25 weight percent.

Beneficial effects: The sum of SiO₂ and Al₂O₃ contents in the waste brick fine aggregate is at least greater than 70 weight percent, optionally greater than 80.0 weight percent. Under this condition, the recycled fine aggregate may achieve good hydration.

Optionally, in the step (1), the temperature for the soaking modification is 5-20 degrees Celsius, and the time is 15-20 hours.

Optionally, the organosilicon compound is one or any combination of tetraethyl orthosilicate, a silane coupling agent, tetramethoxysilane, γ-glycidoxypropyltrimethoxysilane and dimethyl silicone oil.

Beneficial effects: The above organosilicon compounds may improve the hydrophobicity of fine aggregate, reduce the damage caused by moisture to the internal structure of fine aggregate, thereby improving the crack resistance of concrete.

Optionally, in the step (2), the recycled coarse aggregate is obtained by crushing and screening waste concrete and then mixing with sand and/or coarse crushed stone, with a particle size of 5-25 millimeters.

Optionally, the mass ratio of the waste concrete to sand and/or coarse crushed stone is 1:(1-5).

Optionally, in the step (2), the silica sol solution has a mass concentration of 4-25%.

The silica sol is a neutral silica sol, and the silica sol has a particle size of 20-50 nanometers.

Optionally, in the step (2), the soaking temperature is 3-20 degrees Celsius, and the time is 5-8 hours.

Optionally, the additive in the step (3) is a polycarboxylate high-performance water-reducing agent.

A recycled aggregate concrete prepared by a process for improving crack resistance of recycled aggregate concrete is provided.

Compared with the prior art, the present disclosure has the following advantages and technical effects.

The process for improving crack resistance of recycled aggregate concrete provided by the present disclosure significantly enhances crack resistance of concrete compared to the prior art. By soaking fine aggregate in an organosilicon compound, the interfacial bonding force between aggregate and cement paste is improved, reducing the generation of microcracks. Meanwhile, the dense layer formed by the reaction of silica sol and quicklime enhances the durability of coarse aggregate, further improving crack resistance of concrete. In addition, the present disclosure also utilizes industrial wastes such as carbide slag and fly ash, which not only reduces costs but also achieves resource recycling. The combined action of these measures enables recycled aggregate concrete to maintain high strength and good workability while significantly improving its crack resistance, extending its service life, and is of great significance for promoting green building and sustainable development.

### BRIEF DESCRIPTION OF THE DRAWING

The FIGURE is a flowchart of a process for improving crack resistance of recycled aggregate concrete.

### DETAILED DESCRIPTION OF THE EMBODIMENTS

The technical schemes in the embodiments of the present disclosure will be clearly and completely described below. It is apparent that the described embodiments are only a part of the embodiments of the present disclosure, and not all of them. All other embodiments obtained by a person of ordinary skill in the art based on the embodiments of the present disclosure without creative efforts shall fall within the protection scope of the present disclosure.

To make the above objectives, features, and advantages of the present disclosure more comprehensible, a further detailed description of the present disclosure is provided below in conjunction with specific embodiments.

As shown in the FIGURE, an embodiment of the present disclosure provides a process for improving crack resistance of recycled aggregate concrete, including the following steps:
(1) soaking recycled fine aggregate in an organosilicon compound for modification, thereby obtaining modified fine aggregate;
(2) soaking recycled coarse aggregate in a silica sol solution, then adding quicklime, thereby obtaining modified recycled coarse aggregate; and
(3) mixing cement, carbide slag, fly ash and an additive with water until uniform, then sequentially adding the modified fine aggregate and the modified recycled coarse aggregate and mixing uniformly, finally performing later-stage curing to obtain the recycled aggregate concrete.

In an optional embodiment, the mass ratio of the cement, carbide slag, fly ash, additive, modified fine aggregate and modified coarse aggregate is 1:(0.1-0.3):(0-0.3):(0.01-0.05):(0.2-0.5):(0.2-0.5).

In a more optional embodiment, the mass ratio of cement, carbide slag, fly ash, polycarboxylate high-performance water-reducing agent, modified fine aggregate and modified coarse aggregate is 1:0.2:0.2:0.03:0.4:0.3.

The amount of water added should be such that the water-cement ratio of the concrete system is controlled within the range of 0.35-0.60 water/cement.

In an optional embodiment, the recycled fine aggregate is waste brick fine aggregate, and its particle size is 0.2-6 millimeters.

In an optional embodiment, the waste brick fine aggregate has an SiO₂ content of 55-61 weight percent and an Al₂O₃ content of 22-25 weight percent.

The sum of SiO₂ and Al₂O₃ contents in the waste brick fine aggregate is at least greater than 70 weight percent, optionally greater than 80.0 weight percent. Under this condition, good hydration of the recycled fine aggregate may be achieved.

In an optional embodiment, in the step (1), the temperature for the soaking modification is 5-20 degrees Celsius, and the time is 15-20 hours.

In an optional embodiment, the organosilicon compound is selected from one or any combination of tetraethyl orthosilicate, a silane coupling agent, tetramethoxysilane, γ-glycidoxypropyltrimethoxysilane and dimethyl silicone oil. In some typical but non-limiting embodiments, ethyl silicate may be individually selected as the organosilicon compound. In other embodiments, an organosilicon compound obtained by mixing tetramethoxysilane and γ-glycidoxypropyltrimethoxysilane at a mass ratio of 1:1 may also be selected as the organosilicon compound. In other embodiments, an organosilicon compound obtained by mixing tetraethyl orthosilicate and a silane coupling agent at a mass ratio of 1:1 may also be selected as the organosilicon compound. In other embodiments, the organosilicon compound is a composite organosilicon compound obtained by mixing tetramethoxysilane, γ-glycidoxypropyltrimethoxysilane and dimethyl silicone oil at a mass ratio of 1:1:1.

In an optional embodiment, in the step (2), the recycled coarse aggregate is obtained by crushing and screening waste concrete and then mixing with sand and/or coarse crushed stone, and its particle size is 5-25 millimeters.

In an optional embodiment, the mass ratio of the waste concrete to sand and/or coarse crushed stone is 1:(1-5).

In an optional embodiment, in the step (2), the silica sol is a neutral silica sol, and the particle size of the silica sol is 20-50 nanometers. A mass concentration of the neutral silica sol within the range of 4% to 25% may achieve a good modification effect. As examples, the mass concentration of the neutral silica sol may be 4%, 10%, 20%, 22%, or 25%.

In an optional embodiment, in the step (2), the soaking temperature is 3-20 degrees Celsius, and the soaking time is 5-8 hours.

In an optional embodiment, the additive in the step (3) is a polycarboxylate high-performance water-reducing agent.

An embodiment of the present disclosure also provides a recycled aggregate concrete prepared by the above process for improving crack resistance of recycled aggregate concrete.

Unless otherwise specified, room temperature or normal temperature in the embodiments of the present disclosure refers to 25±3 degrees Celsius.

Unless otherwise specified, the raw materials in the embodiments of the present disclosure are all obtained through commercial purchase.

Among them, the recycled fine aggregate is waste brick fine aggregate with a particle size of 0.2-6 millimeters.

The recycled coarse aggregate has a particle size of 5-25 millimeters; and the carbide slag and fly ash have a specific surface area of not less than 300 square meters per kilogram.

The waste concrete and waste brick fine aggregate are collected from a construction site and a demolition site in Wuhan.

In the following embodiments, “later-stage curing” refers to curing at normal temperature under a relative humidity of above 90%.

### Embodiment 1

A process for improving crack resistance of recycled aggregate concrete includes the following steps:
(1) recycled fine aggregate (with an SiO₂ content of 58.3 weight percent and an Al₂O₃ content of 22.5 weight percent) is soaked in an organosilicon compound (tetraethyl orthosilicate) at 10 degrees Celsius for 18 hours for modification, thereby obtaining modified fine aggregate;
(2) recycled coarse aggregate (a mixture of waste concrete and sand and/or coarse crushed stone at a mass ratio of 1:2) is soaked in a neutral silica sol solution with a mass concentration of 20% (particle size: 20-50 nanometers) at 16 degrees Celsius for 7 hours, then quicklime is added for further modification for 1.5 hours, thereby obtaining modified recycled coarse aggregate; and
(3) cement, carbide slag, fly ash and an additive are mixed with water and stirred uniformly, then the modified fine aggregate and the modified recycled coarse aggregate are sequentially added and mixed uniformly, where the mass ratio of cement, carbide slag, fly ash, polycarboxylate high-performance water-reducing agent, modified fine aggregate and modified coarse aggregate is 1:0.2:0.2:0.03:0.4:0.3, the amount of water added is 0.4 water-cement ratio, finally later-stage curing is performed, and recycled aggregate concrete is obtained.

### Embodiment 2

A process for improving crack resistance of recycled aggregate concrete includes the following steps:
(1) recycled fine aggregate (with an SiO₂ content of 55.8 weight percent and an Al₂O₃ content of 24.9 weight percent) is soaked in an organosilicon compound (a mixture of tetramethoxysilane and γ-glycidoxypropyltrimethoxysilane at a mass ratio of 1:1) at 17 degrees Celsius for 15 hours for modification, thereby obtaining modified fine aggregate;
(2) recycled coarse aggregate (a mixture of waste concrete and sand and/or coarse crushed stone at a mass ratio of 1:3) is soaked in a neutral silica sol solution with a mass concentration of 22% (particle size: 20-50 nanometers) at 20 degrees Celsius for 5 hours, then quicklime is added for further modification for 1 hour, thereby obtaining modified recycled coarse aggregate; and
(3) cement, carbide slag, fly ash and an additive are mixed with water and stirred uniformly, then the modified fine aggregate and the modified recycled coarse aggregate are sequentially added and mixed uniformly, where the mass ratio of cement, carbide slag, fly ash, polycarboxylate high-performance water-reducing agent, modified fine aggregate and modified coarse aggregate is 1:0.1:0.1:0.05:0.2:0.2, the amount of water added is 0.35 water-cement ratio, finally later-stage curing is performed, and recycled aggregate concrete is obtained.

### Embodiment 3

A process for improving crack resistance of recycled aggregate concrete includes the following steps:
(1) recycled fine aggregate (with an SiO₂ content of 59.8 weight percent and an Al₂O₃ content of 22.1 weight percent) is soaked in an organosilicon compound (a mixture of tetraethyl orthosilicate and a silane coupling agent at a mass ratio of 1:1) at 13 degrees Celsius for 20 hours for modification, thereby obtaining modified fine aggregate;
(2) recycled coarse aggregate (a mixture of waste concrete and sand and/or coarse crushed stone at a mass ratio of 1:2) is soaked in a neutral silica sol solution with a mass concentration of 10% (particle size: 20-50 nanometers) at 11 degrees Celsius for 5 hours, then quicklime is added for further modification for 1.5 hours, thereby obtaining modified recycled coarse aggregate; and
(3) cement, carbide slag, fly ash and an additive are mixed with water and stirred uniformly, then the modified fine aggregate and the modified recycled coarse aggregate are sequentially added and mixed uniformly, where the mass ratio of cement, carbide slag, fly ash, polycarboxylate high-performance water-reducing agent, modified fine aggregate and modified coarse aggregate is 1:0.3:0.3:0.01:0.5:0.5, the amount of water added is 0.60 water-cement ratio, finally later-stage curing is performed, and recycled aggregate concrete is obtained.

### Embodiment 4

A process for improving crack resistance of recycled aggregate concrete includes the following steps:
(1) recycled fine aggregate (with an SiO₂ content of 60.1 weight percent and an Al₂O₃ content of 23.7 weight percent) is soaked in an organosilicon compound (tetraethyl orthosilicate) at 20 degrees Celsius for 17 hours for modification, thereby obtaining modified fine aggregate;
(2) recycled coarse aggregate (a mixture of waste concrete and sand and/or coarse crushed stone at a mass ratio of 1:1) is soaked in a neutral silica sol solution with a mass concentration of 4% (particle size: 20-50 nanometers) at 18 degrees Celsius for 8 hours, then quicklime is added for further modification for 2 hours, thereby obtaining modified recycled coarse aggregate; and
(3) cement, carbide slag, fly ash and an additive are mixed with water and stirred uniformly, then the modified fine aggregate and the modified recycled coarse aggregate are sequentially added and mixed uniformly, where the mass ratio of cement, carbide slag, polycarboxylate high-performance water-reducing agent, modified fine aggregate and modified coarse aggregate is 1:0.1:0.02:0.4:0.2. The amount of water added is 0.5 water-cement ratio, finally later-stage curing is performed, and recycled aggregate concrete is obtained.

### Embodiment 5

A process for improving crack resistance of recycled aggregate concrete includes the following steps:
(1) recycled fine aggregate (with an SiO₂ content of 55.6 weight percent and an Al₂O₃ content of 22.9 weight percent) is soaked in an organosilicon compound (a mixture of tetramethoxysilane, γ-glycidoxypropyltrimethoxysilane and dimethyl silicone oil at a mass ratio of 1:1:1) at 5 degrees Celsius for 16 hours for modification, thereby obtaining modified fine aggregate;
(2) recycled coarse aggregate (a mixture of waste concrete and sand and/or coarse crushed stone at a mass ratio of 1:5) is soaked in a neutral silica sol solution with a mass concentration of 25% (particle size: 20-50 nanometers) at 3 degrees Celsius for 6 hours, then quicklime is added for further modification for 1 hour, thereby obtaining modified recycled coarse aggregate; and
(3) cement, carbide slag, fly ash and an additive are mixed with water and stirred uniformly, then the modified fine aggregate and the modified recycled coarse aggregate are sequentially added and mixed uniformly, where the mass ratio of cement, carbide slag, fly ash, polycarboxylate high-performance water-reducing agent, modified fine aggregate and modified coarse aggregate is 1:0.3:0.1:0.04:0.2:0.5, the amount of water added is 0.4 water-cement ratio, finally later-stage curing is performed, and recycled aggregate concrete is obtained.

### Comparative Example 1

A preparation method of recycled aggregate concrete differs from Embodiment 1 only in that the modification process in the step (1) is not included, and the modified recycled fine aggregate in the step (3) is replaced with an equal mass of recycled fine aggregate. The remaining process steps and parameters are the same as those in Embodiment 1.

### Comparative Example 2

A preparation method of recycled aggregate concrete differs from Embodiment 1 only in that the modification process in the step (2) is not included, and the modified recycled coarse aggregate in the step (3) is replaced with an equal mass of recycled coarse aggregate. The remaining process steps and parameters are the same as those in Embodiment 1.

### Comparative Example 3

A preparation method of recycled aggregate concrete differs from Embodiment 1 only in that, in the step (3), all raw materials are directly mixed and stirred uniformly at once, specifically:
(3) cement, carbide slag, fly ash, an additive, modified fine aggregate, modified recycled coarse aggregate and water are mixed and stirred uniformly, and finally later-stage curing is performed, and recycled aggregate concrete is obtained.

The remaining process steps and parameters are the same as those in Embodiment 1.

### Comparative Example 4

A preparation method of recycled aggregate concrete differs from Embodiment 1 only in that the raw material addition ratio in the step (3) is as follows: the mass ratio of cement, carbide slag, fly ash, polycarboxylate high-performance water-reducing agent, modified fine aggregate and modified coarse aggregate is 1:0.5:0.5:0.01:0.6:0.1, and the amount of water added is 0.55 water-cement ratio.

The remaining process steps and parameters are the same as those in Embodiment 1.

### Comparative Example 5

A preparation method of recycled aggregate concrete differs from Embodiment 1 only in that the raw materials in the step (3) do not include carbide slag.

The remaining process steps and parameters are the same as those in Embodiment 1.

### Comparative Example 6

A preparation method of recycled aggregate concrete differs from Embodiment 4 only in that the raw materials in the step (3) do not include carbide slag.

The remaining process steps and parameters are the same as those in Embodiment 4.

### Technical Effects:

The recycled aggregate concretes prepared in Embodiments 1-5 and Comparative Examples 1-6 are subjected to mechanical performance testing:
Standard test blocks are made according to GB/T 50081-2019 Standard for Test Methods of Physical and Mechanical Properties of Concrete, and the compressive strength of the standard test blocks after 28 days of curing is measured;
According to GB/T 50081-2019 Standard for Test Methods of Physical and Mechanical Properties of Concrete, concrete samples are made into cylindrical specimens with a diameter of 150 millimeters, then the splitting tensile strength test is conducted according to GB/T 50081-2019 Standard for Test Methods of Physical and Mechanical Properties of Concrete, and the splitting tensile strength of the recycled aggregate concrete samples is calculated; and
The early-age crack resistance of the obtained concretes is tested according to GB/T 50082-2009 Standard for Test Methods of Long-term Performance and Durability of Ordinary Concrete.

The experimental results are shown in Table 1.

TABLE 1

| | | | Number of | Total cracking |
|---|---|---|---|---|
| | 28-day | Splitting | cracks per | area per unit |
| | compressive | tensile | unit area/ | area (square |
| | strength | strength | square | millimeters per |
| | (Megapascal) | (Megapascal) | meter | square meter) |
| Embodiment 1 | 91 | 4.21 | 1.3 | 22 |
| Embodiment 2 | 89 | 4.18 | 2.1 | 31 |
| Embodiment 3 | 87 | 4.06 | 1.7 | 27 |
| Embodiment 4 | 90 | 4.55 | 1.5 | 29 |
| Embodiment 5 | 85 | 4.78 | 1.8 | 30 |
| Comparative Example 1 | 68 | 2.29 | 4.5 | 57 |
| Comparative Example 2 | 62 | 2.13 | 4.9 | 62 |
| Comparative Example 3 | 55 | 1.98 | 4.8 | 77 |
| Comparative Example 4 | 63 | 2.07 | 4.1 | 63 |
| Comparative Example 5 | 62 | 3.12 | 5.2 | 59 |
| Comparative Example 6 | 51 | 3.07 | 5.1 | 64 |

From the above results, it may be seen that the modification of recycled coarse aggregate and recycled fine aggregate in the present disclosure effectively improves the cracking resistance of concrete, and the technical effect of their combined addition is greater than the sum of the effects of individual additions, exhibiting a certain synergistic effect. Moreover, the addition of carbide slag effectively improves the splitting tensile performance and compressive strength of the product, further enhancing the mechanical properties of the concrete. In addition, the two-stage mixing process in the present disclosure also effectively improves the mechanical properties of concrete, helps reduce voids between aggregates, increases the compactness and strength of concrete, and together with the addition of modified recycled coarse aggregate and modified recycled fine aggregate, helps reduce the generation of microcracks at the interface and improves the crack resistance of concrete.

The above are only optional specific embodiments of the present disclosure, but the protection scope of the present disclosure is not limited thereto. Any changes or substitutions that may be easily conceived by those skilled in the art within the technical scope disclosed in the present disclosure shall fall within the protection scope of the present disclosure. Therefore, the protection scope of the present disclosure shall be subject to the protection scope of the claims.

What is claimed is:

1. A process for improving crack resistance of recycled aggregate concrete, comprising following steps:
(1) soaking recycled fine aggregate in an organosilicon compound for modification, thereby obtaining modified fine aggregate;
(2) soaking recycled coarse aggregate in a silica sol solution, then adding quicklime, thereby obtaining modified recycled coarse aggregate; and
(3) mixing cement, carbide slag, fly ash and an additive with water until uniform, then sequentially adding the modified fine aggregate and the modified recycled coarse aggregate and mixing uniformly, finally performing later-stage curing to obtain the recycled aggregate concrete;
wherein in the step (1), the recycled fine aggregate is waste brick fine aggregate with a particle size of 0.2-6 millimeters;
the waste brick fine aggregate has an SiO₂ content of 55-61 weight percent and an Al₂O₃ content of 22-25 weight percent;
in the step (2), the recycled coarse aggregate is obtained by crushing and screening waste concrete and then mixing with coarse crushed stone, with a particle size of 5-25 millimeters; and
an amount of the water added is controlled to maintain a water-cement ratio of a concrete system within a range of 0.35-0.60 water/cement.

2. The process for improving the crack resistance of the recycled aggregate concrete according to claim 1, wherein in the step (1), a temperature for soaking modification is 5-20 degrees Celsius and a time is 15-20 hours.

3. The process for improving the crack resistance of the recycled aggregate concrete according to claim 1, wherein in the step (1), the organosilicon compound is selected from one or any combination of tetraethyl orthosilicate, a silane coupling agent, tetramethoxysilane, γ-glycidoxypropyltrimethoxysilane and dimethyl silicone oil.

4. The process for improving the crack resistance of the recycled aggregate concrete according to claim 1, wherein a mass ratio of the waste concrete to at least one of sand or the coarse crushed stone is 1:(1-5).

5. The process for improving the crack resistance of the recycled aggregate concrete according to claim 1, wherein in the step (2), a silica sol is a neutral silica sol with a particle size of 20-50 nanometers.

6. The process for improving the crack resistance of the recycled aggregate concrete according to claim 1, wherein in the step (2), a soaking temperature is 3-20 degrees Celsius and a soaking time is 5-8 hours.

7. A recycled aggregate concrete prepared by the process for improving the crack resistance of the recycled aggregate concrete according to claim 1.
